(19) United States
(12) Patent Application Publication
(10) Pub. No.: US 2024/0178474 A1
(43) Pub. Date: May 30, 2024

(54) BATTERY MODULE AND BATTERY PACK INCLUDING THE SAME

(71) Applicant: LG ENERGY SOLUTION, LTD., Seoul (KR)

(72) Inventors: Min Seop KIM, Daejeon (KR); Junyeob SEONG, Daejeon (KR); Jongpil JEON, Daejeon (KR)

(21) Appl. No.: 18/284,063

(22) PCT Filed: Aug. 17, 2022
(86) PCT No.: PCT/KR2022/012287

§ 371 Date: Sep. 25, 2023

(30) Foreign Application Priority Data
Aug. 20, 2021 (KR) 10-2021-0109847

(51) Int. Cl. H01M 10/6551; H01M 10/613; H01M 50/211; H01M 50/271; H01M 50/507

(52) U.S. Cl. CPC H01M 10/6551; H01M 10/613; H01M 50/211; H01M 50/271; H01M 50/507

(57) ABSTRACT

A battery module including a battery cell stack in which a plurality of battery cells are stacked, a housing that surrounds the battery cell stack, a busbar connected to an electrode lead protruding from the battery cell, and a first heat transfer member formed between the busbar and the battery cell stack, where the first heat transfer member is in contact with the housing.

### CROSS-REFERENCE TO RELATED APPLICATIONS

This application is a US national stage of international application No. PCT/KR2022/012287 filed on Aug. 17, 2022, and claims the benefit of Korean Patent Application No. 10-2021-0109847 filed on Aug. 20, 2021, the entire contents of which are incorporated herein by reference.

### TECHNICAL FIELD

The present disclosure relates to a battery module and a battery pack including the same, and more particularly to a battery module having a novel cooling structure and a battery pack including the same.

### BACKGROUND

Along with the technology development and increased demand for mobile devices, the demand for batteries as energy sources is increasing rapidly. In particular, a secondary battery has attracted considerable attention as an energy source for power-driven devices, such as an electric bicycle, an electric vehicle, and a hybrid electric vehicle, as well as an energy source for mobile devices, such as a mobile phone, a digital camera, a laptop computer and a wearable device.

Small-sized mobile devices use one or several battery cells for each device, whereas medium- or large-sized devices such as vehicles require high power and large capacity. Therefore, a medium- or large-sized battery module having a plurality of battery cells electrically connected to one another is used.

The medium- or large-sized battery module is preferably manufactured to have as small a size and weight as possible. Consequently, a prismatic battery, a pouch-shaped battery or the like, which can be stacked with high integration and has a small weight relative to capacity, is mainly used as a battery cell of the medium- or large-sized battery module. Such a battery module has a structure in which a plurality of cell assemblies including a plurality of unit battery cells are connected in series to obtain high output. The battery cell includes positive and negative current collectors, a separator, an active material, an electrolyte, and the like, and thus can be repeatedly charged and discharged through an electrochemical reaction between components.

Meanwhile, in recent years, as the need for large-capacity structures including their utilization as an energy storage source is growing, there is an increasing demand for battery packs having a multi-module structure formed by assembling a plurality of battery modules in which a plurality of secondary batteries are connected in series and/or in parallel.

Meanwhile, when a plurality of battery cells are connected in series or in parallel to configure a battery pack, it is common to configure a battery module composed of at least one battery cell first and then configure a battery pack by using the at least one battery module and adding other components.

FIG. 1 is an exploded perspective view of a conventional battery module. FIG. 2 is a partial cross-sectional view of the battery module of FIG. 1.

Referring to FIGS. 1 and 2, the conventional battery module 10 includes a battery cell stack 12 in which a plurality of battery cells 11 are stacked and a housing 20 that houses the battery cell stack 12. The housing 20 may include a U-shaped part 30 that covers the side surfaces and the lower surface of the battery cell stack 12, and an upper plate 40 that covers the upper surface of the battery cell stack. In addition, the battery module 10 includes a pair of end plates 15 that cover the front and rear surfaces of the battery cell stack 12, respectively, and a busbar assemblies for electrically connecting the electrode leads 14 of the plurality of battery cells 11 may be formed between the battery cell stack 12 and the end plates 15.

Here, each busbar assembly is constituted to include a busbar frame 13 through which the electrode leads 14 of each battery cell 11 pass, and a busbar 16 mounted on the busbar frame 13 and connected to the electrode leads 14 passing through the busbar frame 13 by welding or the like.

At this time, because the heat generated from the busbar 16 does not have a direct cooling path, the heat generated may be transferred through the electrode leads 14, and transferred through the battery cell 11, the thermal conductive resin layer 31 formed on the bottom part of the housing 20, and the bottom part of the housing 20.

However, in recent years, the need for high capacity, high energy, fast charging, and the like is continuously increasing, and the amount of current flowing through the busbar also tends to increase. Thus, heat is generated in the busbar due to the high current flowing through the busbar, and it is difficult to effectively cool the generated heat through a conventional cooling structure alone. Therefore, there is a need for a novel structure that can directly contact the busbar and cool the busbar in order to cool the heat generated.

### SUMMARY

It is an objective of the present disclosure to provide a battery module that can solve the heat generation problem of a busbar and a battery pack including the same.

However, the objectives of the present disclosure are not limited to the aforementioned objects, and other objectives which are not mentioned herein should be clearly understood by those skilled in the art from the following detailed description and the accompanying drawings.

According to one embodiment of the present disclosure, there is provided a battery module comprising: a battery cell stack in which a plurality of battery cells are stacked, a housing that surrounds the battery cell stack, a busbar connected to an electrode lead protruding from the battery cell, and a first heat transfer member formed between the busbar and the battery cell stack, wherein the first heat transfer member comes into contact with the housing.

The battery module may further include a first heat transfer pad formed between the busbar and the first heat transfer member and in contact with the busbar.

The first heat transfer member may include a first bent part.

The housing may include a frame covering the lower surface and both side surfaces of the battery cell stack, and an upper plate covering an upper surface of the battery cell stack, and the first bent part may be bent to be adjacent to the upper plate.

One end of the first heat transfer member may come into contact with the inside surface of the upper plate.

The busbar and the first heat transfer pad may be in surface contact, and the first heat transfer pad and the first heat transfer member may come into surface contact.

In the battery module according to another embodiment of the present disclosure, the first bent part may be bent to be adjacent to the bottom part of the frame member.

One end of the first heat transfer member may come into contact with an inner lower end of the frame member.

The battery module according to yet another embodiment of the present disclosure may further include a pair of end plates covering the front and rear surfaces of the battery cell stack, respectively, that are open through the housing, and a second heat transfer pad formed between the inside surface of the end plate and the busbar.

The battery module may further include a third heat transfer pad formed to come into contact with the outside surface of the end plate, and a second heat transfer member formed to come into contact with the third heat transfer pad.

The second heat transfer member may include a second bent part that is bent in the direction of the upper plate.

One end of the second heat transfer member comes into contact with the outside surface of the upper plate, and heat from the busbar may be sequentially transferred and discharged through the second heat transfer pad, the end plate, the third heat transfer pad, the second heat transfer member, and the upper plate.

According to yet another embodiment of the present disclosure, there can be provided a battery pack comprising the above-mentioned battery module.

The battery module according to one embodiment of the present disclosure has a novel form of busbar cooling structure and thus can solve the problem of busbar heat generation in a high current and fast charging environment. In addition, the stability of the battery module can be enhanced by solving the heat generation problem.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is an exploded perspective view of a conventional battery module;

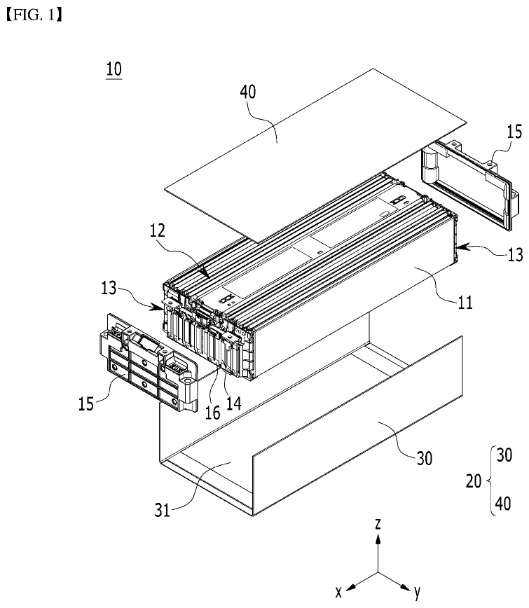

FIG. 2 is a partial cross-sectional view of the battery module of FIG. 1;

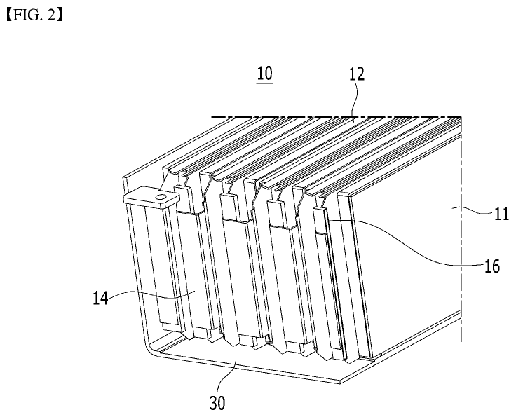

FIG. 3 is a perspective view of a battery module according to an embodiment of the present disclosure;

FIG. 4 is an enlarged cross-sectional view in the yz plane and along the P1 plane with reference to the line A-A′ in FIG. 3;

FIG. 5 is a perspective view of a first heat transfer member of the present disclosure;

FIG. 6 is an illustration of a coupling relationship of partial components of the present disclosure;

FIG. 7 is a partial perspective view of the components of a battery module according to another embodiment of the present disclosure;

FIG. 8 is a partial perspective view of components of a battery module according to another embodiment of the present disclosure; and

FIG. 9 is a cross-sectional view along plane P2 of FIG. 8.

### DETAILED DESCRIPTION

Hereinafter, various embodiments of the present disclosure will be described in detail with reference to the accompanying drawings so that those skilled in the art can easily carry out the various embodiments. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggeratedly illustrated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion and does not particularly mean the certain part “above” or “on” toward an opposite direction of gravity.

Further, throughout the description, when a portion is referred to as “including” or “comprising” a certain component, it means that the portion can further include other components, without excluding the other components, unless otherwise stated.

Further, throughout the description, when it is referred to as “planar”, it means when a target portion is viewed from the upper side, and when it is referred to as “cross-sectional”, it means when a target portion is viewed from the side of a cross section cut vertically.

The terms “first,” “second,” etc. are used to explain various components, but the components should not be limited by the terms. These terms are only used to distinguish one component from the other component.

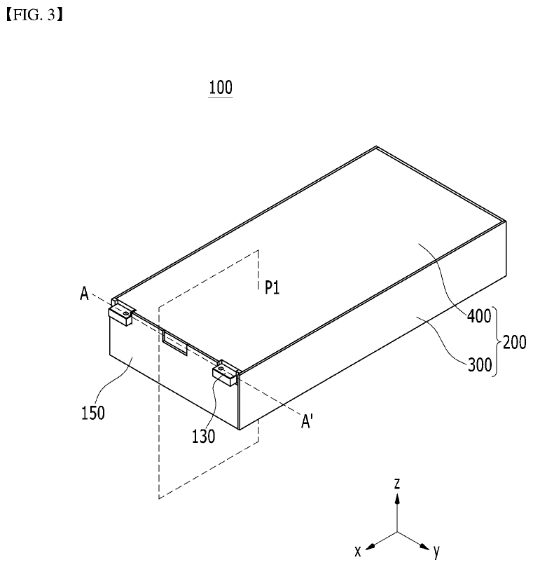

Hereinafter, a battery module according to an embodiment of the present disclosure will be described with reference to FIGS. 3 to 6.

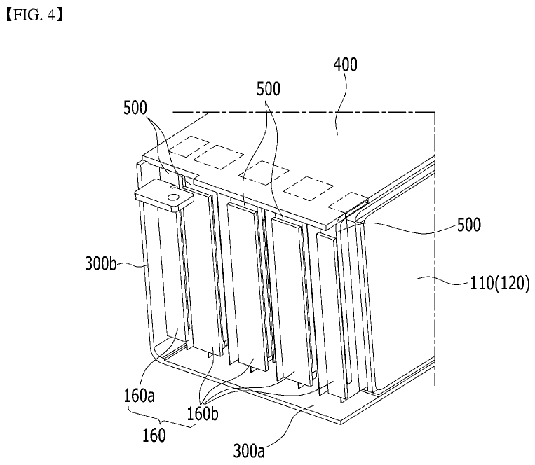

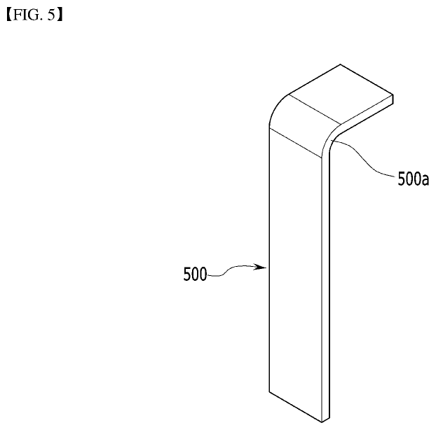

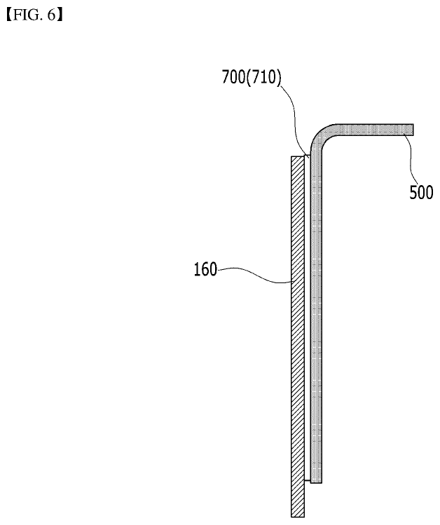

FIG. 3 is a perspective view of a battery module according to an embodiment of the present disclosure. FIG. 4 is an enlarged cross-sectional view in the yz plane along the P1 plane with reference to the cutting line A-A′ in FIG. 3. FIG. 5 is a perspective view of a first heat transfer member of the present disclosure. FIG. 6 is an illustration of a coupling relationship of partial components of the present disclosure.

Referring to FIGS. 3 and 4, a battery module 100 according to an embodiment of the present disclosure includes a battery cell stack 120 in which a plurality of battery cells 110 are stacked, a housing 200 that surrounds the battery cell stack 120, and a busbar 160 connected to the electrode lead 140 protruding from the battery cell 110.

The battery cell 110 is a secondary battery and can be configured into a pouch-type secondary battery. A plurality of battery cells 110 can be included, and the plurality of battery cells 110 can be mutually stacked to be electrically connected to each other, thereby forming a battery cell stack 120 and forming a cell assembly including the battery cell stack 120. The plurality of battery cells 110 may include an electrode assembly, a cell case, and an electrode lead 140 protruding from the electrode assembly.

The housing 200 includes a frame 300 which is open in the upper part, the front part and the rear part thereof and covers the lower surface and both side surfaces of the battery cell stack 120, and an upper plate 400 that covers an upper surface of the battery cell stack 120. However, the housing 200 is not limited thereto, and can be replaced with a frame having another shape such as an L-shaped frame or a mono-frame surrounding the battery cell stack 120 except the front and rear surfaces. The battery cell stack 120 housed inside the housing 200 can be physically protected through the housing 200. The frame 300 may include a bottom part 300a that supports the lower surface of the battery cell stack 120, and side parts 300b each extending upward from both ends of the bottom part 300a.

The upper plate 400 may cover the open upper part of the housing 200. The end plate 150 can cover the front and rear surfaces of the battery cell stack 120 that are open through the housing 200. The end plate 150 can be weld-coupled with the front and rear edges of the upper plate 400 and the front and rear edges of the housing 200.

A busbar frame 130 can be formed between the end plates 150 and the front and rear surfaces of the battery cell stack 120. A plurality of busbars 160 mounted on the busbar frame 130 can be formed to protrude from the battery cells 110 and come into contact with the electrode leads 140 mounted on the busbar frame 130. The busbar 160 may include a terminal busbar 160a and a sensing busbar 160b.

Conventional battery modules do not have a direct cooling path for the busbar, and thus, heat from the busbar is discharged only through a path continuing to the busbar, the electrode lead, the battery cell, the thermally conductive resin layer, and the bottom part of the housing. However, in a situation in which the flow of a high current, such as fast charging causes the busbar to generate high heat in a short period of time, a cooling structure capable of minimizing the temperature rise of the busbar is required.

Therefore, referring to FIGS. 4 and 6, the battery module 100 according to the present embodiment includes a first heat transfer member 500 that is formed between the busbar 160 and the battery cell stack 120. Further, the first heat transfer member 500 comes into contact with the housing 200. In addition, the battery module 100 according to the present embodiment includes a first heat transfer pad 710 that is formed between the busbar 160 and the first heat transfer member 500 and comes into contact with the busbar 160. At this time, components such as double-sided tape may be included instead of the first heat transfer pad 710.

Referring to FIG. 6, the battery module according to the present embodiment may be formed to come into contact with the busbar 160, the first heat transfer pad 710, and the first heat transfer member 500 in this order. Therefore, heat generated from the busbar 160 may be transferred to the first heat transfer member 500 through the first heat transfer pad 710. Further, as described above, heat generated from the busbar 160 can be effectively discharged through the housing 200 because the first heat transfer member 500 comes into contact with the housing 200.

Further, the first heat transfer pad 710 may not only be a component for heat transfer, but may also enable close contact between the first heat transfer member 500 and the busbar 160. As will be described later, the first heat transfer member 500 and the busbar 160, which are typically formed of a heat conductor, are difficult to adhere and fix only with both structures, but when the first heat transfer pad 710 is introduced between the first heat transfer member 500 and the busbar 160, all of the above structures can be adhesively fixed, and a stable cooling path can be secured. Therefore, the heat transfer pad 700 enables not only heat transfer but also stable coupling of each component, and thus can serve to form a stable cooling path.

At this time, the busbar 160 and the first heat transfer pad 710 may come into surface contact, and the first heat transfer pad 710 and the first heat transfer member 500 may come into surface contact. Therefore, the heat transfer path and the busbar cooling path as described above can be formed to thereby enable effective busbar cooling. In particular, the contact area can be increased through surface contact, thereby increasing the cooling efficiency.

The cooling structure simplifies the cooling path and reduces the types of battery module components involved in the cooling path as compared to a conventional cooling structure, thereby enabling quick and effective busbar cooling.

Referring to FIG. 5, the first heat transfer member 500 may include a first bent part 500a. The first bent part 500a is illustrated as having a gently curved shape, but is not limited thereto and may have a right-angled shape. Centering on the first bent part 500a, each end of the first heat transfer member 500 may be formed to have a right angle, but is not limited thereto. As will be described later, the first heat transfer member 500 may be formed to correspond to an angle between the busbar 160 and the upper plate 400 depending on the role of the first heat transfer member 500 forming a cooling path between the busbar 160 and the upper plate 400.

Referring back to FIG. 4, the first bent part 500a may be bent to be adjacent to the upper plate 400 among the housing 200. That is, the first bent part 500a may be formed on the first heat transfer member 500 to be adjacent to the upper plate 400. At this time, a dotted line portion shown in the upper plate 400 of FIG. 4 indicates a region where the first heat transfer member 500 comes into contact with the housing 200, i.e., the upper plate 400.

Furthermore, by forming the first bent part 500a as described above, one end of the first heat transfer member 500 can come into contact with the inside surface of the upper plate 400. Therefore, the area of the upper plate 400 with which the one end of the first heat transfer member 500 contacts may correspond to the size of the one end of the first heat transfer member 500.

The one end of the first heat transfer member 500 comes into contact with the upper plate 400, so that the heat transfer path continuing to the busbar 160, the first heat transfer pad 710 and the first heat transfer member 500 as described above is connected to the upper plate 400, and heat generated from the busbar 160 may be transferred to the outside of the battery module through the upper plate 400. Due to the structure in which heat is sequentially transmitted and discharged as described above, the heat of the busbar generated in high current conditions such as fast charging can be effectively discharged, and the stability of the battery module can be secured.

The first heat transfer member 500 according to the present embodiment may be formed of a material having thermal conductivity, and more specifically, may be formed of a heat conductor. Further, the first heat transfer pad 710 according to the present embodiment may be formed of a material that is electrically insulating but thermally conductive. Therefore, the first heat transfer pad 710 may enable heat transfer while maintaining the insulation of the busbar 160, and enable heat transfer through the first heat transfer member 500. In particular, the first heat transfer member 500 may also be formed of a material having insulation property, if necessary.

At this time, the first heat transfer pad 710 and the first heat transfer member 500 may be formed considering the number of busbars 160 coming into contact with the first heat transfer pad 710 and the first heat transfer member 500, but are not limited thereto and may be formed in the number that maximizes the cooling of the busbar 160. Therefore, a plurality of the first heat transfer pad 710 and the first heat transfer member 500 or a single first heat transfer pad 710 and a single first heat transfer member 500 may be formed in the battery module.

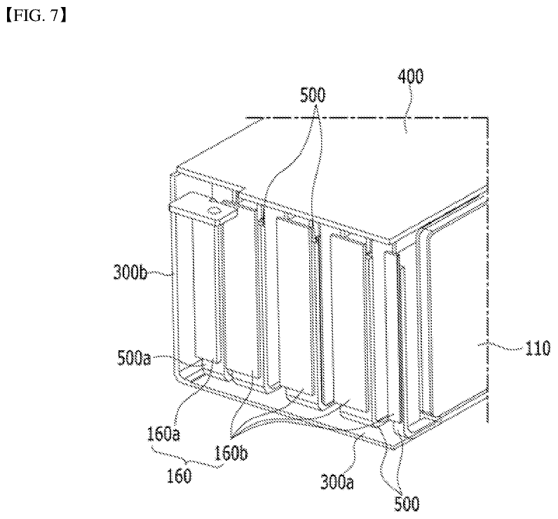

Next, a battery module according to another embodiment of the present disclosure will be described with reference to FIG. 7. Since there are contents that overlap with the contents described above, the contents different from the above contents will be mainly described.

FIG. 7 is a partial perspective view showing the components of a battery module according to another embodiment of the present disclosure.

Referring to FIG. 7, the first heat transfer member 500 according to the present embodiment includes a first bent part 500a, wherein the first bent part 500a may be bent to be adjacent to the bottom part 300a of the frame 300.

That is, the first bent part 500a may be formed on the first heat transfer member 500 to be adjacent to the bottom part 300a of the frame 300. Therefore, the first heat transfer member 500 according to the present embodiment may come into contact with the frame 300 among the housing 200, and more specifically, it may come into contact with the bottom part 300a of the frame 300.

Moreover, as the first bent part 500a is formed as described above, one end of the first heat transfer member 500 may come contact with an inside lower end of the frame 300. That is, one end of the first heat transfer member 500 may come into contact with the inside surface of the bottom part 300a of the frame 300. Therefore, the area of the bottom part 300a of the frame 300 with which the one end of the first heat transfer member 500 contacts may correspond to the size of the one end of the first heat transfer member 500.

At this time, the heat transfer path continuing to the busbar 160, the first heat transfer pad 710 and the first heat transfer member 500 as described above is connected to the bottom part 300a of the frame 300, so that heat can be transferred to the outside of the battery module through the frame 300.

Further, due to the structure in which heat is sequentially transmitted and discharged as described above, the heat of the busbar generated under high current conditions such as fast charging can be effectively discharged, and the stability of the battery module can be secured.

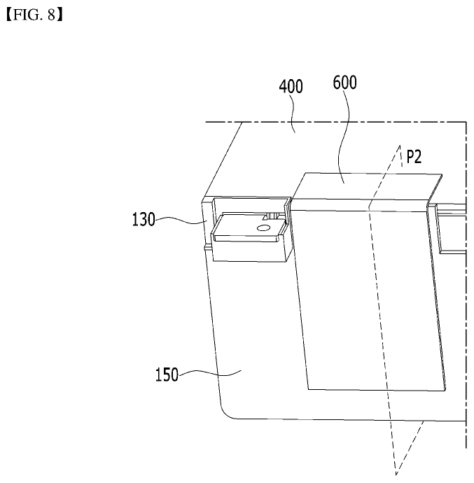

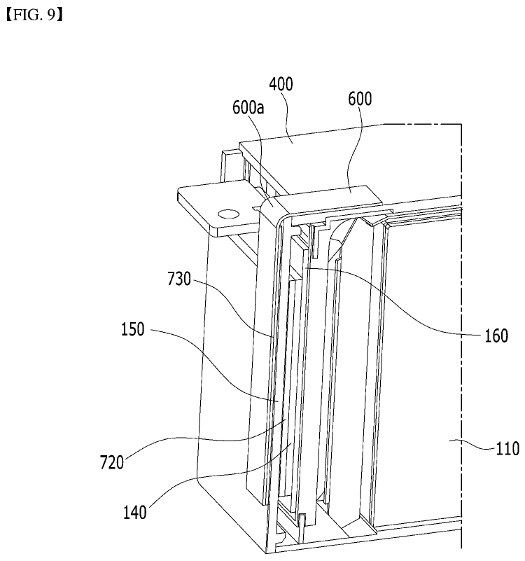

Next, a battery module according to another embodiment of the present disclosure will be described with reference to FIGS. 8 and 9.

FIG. 8 is a partial perspective view of components of a battery module according to another embodiment of the present disclosure. FIG. 9 is a cross-sectional view along plane P2 of FIG. 8.

Referring to FIGS. 8 and 9, the battery module according to the present embodiment may include a second heat transfer pad 720 that is formed between the inside surface of the end plate 150 and the busbar 160. Also, an electrode lead 140 may be formed between the busbar 160 and the second heat transfer pad 720. The busbar 160 and the electrode lead 140 are components having the highest heat generation in fast charging situations, so that heat generated in the busbar 160 and the electrode lead 140 can be effectively transferred through second heat transfer pad 720.

In particular, the battery module according to the present embodiment may include a third heat transfer pad 730 that is formed to be in contact with the outside surface of the end plate 150, and may include a second heat transfer member 600 that is formed to be in contact with the third heat transfer pad 730. More specifically, the battery module according to the present embodiment may include a third heat transfer pad 730 in contact with the outside surface of the end plate 150, and a second heat transfer member 720 that is formed to be in contact with the opposite surface of the third heat transfer pad 730 in contact with the outer surface of the end plate 150.

Heat from the second heat transfer pad 720 may be sequentially transferred through the end plate 150, the third heat transfer pad 730, and the second heat transfer member 600.

The second heat transfer member 600 according to the present embodiment may include a second bent part 600a that is bent in the direction of the upper plate 400. Therefore, one end of the second heat transfer member 600 may come into contact with the outside surface of the upper plate 400, and the upper plate 400 may be included as a component of the present cooling path.

That is, an additional heat transfer path is formed through the second heat transfer member 600 in contact with the outer surface of the upper plate 400, so that the heat from the busbar 160 is sequentially transferred through the second heat transfer pad 720, the end plate 150, the third heat transfer pad 730, the second heat transfer member 600, and the upper plate 400. The path transfers a large amount of heat to the outside and cools the module in fast charging situations, thereby increasing the stability of the battery module itself.

Meanwhile, the second heat transfer member 600 may be formed to have a wider width than that of the first heat transfer member 500, but the width may be of a desired size within a range that maximizes cooling of the busbar.

Next, a battery pack according to another embodiment of the present disclosure will be described.

The battery pack according to the present embodiment includes the battery module described above. Also, it may further include a thermally conductive resin layer and a cooling plate located below the thermally conductive resin layer.

Therefore, as described above, the heat from the busbar 160 to other components may be additionally transferred to the thermal conductive resin layer and the cooling plate. The thermally conductive resin layer and the cooling plate may be formed on both the upper part and the lower part of the battery module. The heat generated by the busbar 160 is transferred and cooled through the thermal conductive resin layer and the cooling plate formed outside the battery module, thereby enabling effective cooling of a large amount of heat generated in fast charging situations.

In addition, the battery pack of the present disclosure may have a structure in which one or more of the battery modules according to the present embodiment are gathered, and packed together with a battery management system (BMS) and a cooling device that control and manage battery's temperature, voltage, etc.

The battery pack can be applied to various devices. Such a device can be applied to a vehicle means such as an electric bicycle, an electric vehicle, or a hybrid vehicle, but the present disclosure is not limited thereto, and is applicable to various devices that can use a battery module, which also falls under the scope of the present disclosure.

Although preferred embodiments of the present disclosure have been described in detail above, the scope of the present disclosure is not limited thereto, and numerous other modifications and embodiments can be devised by those skilled in the art, without departing from the spirit and scope of the principles of the invention described in the appended claims. Further, these modifications should not be understood individually from the technical spirit or perspective of the present disclosure.

1. A battery module comprising:
a battery cell stack comprising a plurality of battery cells,
a housing surrounding the battery cell stack,
a busbar connected to an electrode lead protruding from the battery cell, and
a first heat transfer member formed between the busbar and the battery cell stack,
wherein the first heat transfer member is in contact with the housing.

2. The battery module according to claim 1, further comprising:
a first heat transfer pad between the busbar and the first heat transfer member and in contact with the busbar.

3. The battery module according to claim 1 wherein:
the first heat transfer member comprises a first bent part.

4. The battery module according to claim 3 wherein:
the housing comprises a frame covering a lower surface and both side surfaces of the battery cell stack, and an upper plate covering an upper surface of the battery cell stack, and
the first bent part is bent to be adjacent to the upper plate.

5. The battery module according to claim 4 wherein:
a first end of the first heat transfer member is in contact with an inside surface of the upper plate.

6. The battery module according to claim 2 wherein:
the busbar is in surface contact with the first heat transfer pad, and
the first heat transfer pad is in surface contact with the first heat transfer member.

7. The battery module according to claim 3 wherein:
the housing comprise a frame covering lower surface and both side surfaces of the battery cell stack, and an upper plate covering an upper surface of the battery cell stack, and
the first bent part is bent to be adjacent to a bottom part of the frame.

8. The battery module according to claim 7 wherein:
a first end of the first heat transfer member comes into contact with an inner lower end of the frame.

9. The battery module according to claim 4, further comprising;
a pair of end plates covering front and rear surfaces of the battery cell stack that are open through the housing, and
a second heat transfer pad between an inside surface of the end plate and the busbar.

10. The battery module according to claim 9, further comprising;
a third heat transfer pad in contact with an outside surface of the end plate, and
a second heat transfer member in contact with the third heat transfer pad.

11. The battery module according to claim 10 wherein:
the second heat transfer member comprises a second bent part that is bent in the direction of the upper plate.

12. The battery module according to claim 11 wherein:
a first end of the second heat transfer member is in contact with the outside surface of the upper plate, and
heat is sequentially transferred and discharged from the busbar through the second heat transfer pad, the end plate, the third heat transfer pad, the second heat transfer member, and the upper plate.

13. A battery pack comprising the battery module according to claim 1.
